(19) United States
(12) Patent Application Publication
(10) Pub. No.: US 2024/0140379 A1
(43) Pub. Date: May 2, 2024

(54) BRAKING DEVICE HAVING A SIMULATOR UNIT

(71) Applicant: Continental Automotive Technologies GmbH, Hannover (DE)

(72) Inventors: Mihaita-Florin Siniuc, Valea Ursului (RO); Tudor Ulian, Iasi (RO)

(73) Assignee: Continental Automotive Technologies GmbH, Hannover (DE)

(21) Appl. No.: 18/280,065

(22) PCT Filed: Dec. 14, 2021
(86) PCT No.: PCT/EP2021/085746

§ 371 Date: Sep. 1, 2023

(30) Foreign Application Priority Data
Mar. 10, 2021 (EP) 21465509.4
Mar. 16, 2021 (DE) 10 2021 202 553.6

(51) Int. Cl. B60T 8/40

(52) U.S. Cl. CPC B60T 8/409; B60T 8/4086

(57) ABSTRACT

The invention relates to a brake device (100) for a hydraulic vehicle brake system, comprising at least one simulator unit (1) for generating a counterforce (G) which acts counter to an actuating force (B) and which is fed back to an actuating member (2) of the brake device (100), having at least one hydraulically actuated simulator piston (4), which is axially displaceable in a piston bore (3), and having at least one sealing element (5) for sealing off the simulator piston (4) in the piston bore (3). In order to be able to produce brake devices with different simulator characteristics at lower cost and more efficiently, it is proposed according to the invention that the sealing element (5) is fastened to the simulator piston (4), and slides on a lateral surface (6) of the piston bore (3) when the simulator piston (4) is actuated.

### CROSS-REFERENCE TO RELATED APPLICATIONS

This application is a national stage application, filed under 35 U.S.C. § 371, of International Patent Application No. PCT/EP2021/085746, filed Dec. 14, 2021, which claims priority to European patent application No. 21465509.4, filed Mar. 10, 2021, each of which are incorporated by reference.

### TECHNICAL FIELD

The technical field relates to a brake device having a simulator unit according for a hydraulic motor vehicle brake system, in particular an externally actuatable, electronically controllable brake-by-wire motor vehicle brake system.

### BACKGROUND

Electronically controlled brake systems, in particular so-called brake-by-wire brake systems, are being increasingly used in modern vehicles. Such brake systems have numerous advantages over conventional brake systems. For example, brake operation is possible entirely independently of a driver when required, and can be flexibly adapted to the respective driving situation. The structural space required is reduced in relation to a conventional brake system, and the brake system can furthermore be positioned more flexibly in the vehicle. In their normal braking mode, modern brake-by-wire motor vehicle brake systems are actuated indirectly, and in electronically controlled fashion entirely independently of the driver, by way of sensor-based detection of a driver braking demand. In order to deliver a required system pressure in such a normal braking mode, use is made of a pressure generator which is controllable independently of a driver and which is normally driven by an electric motor.

In conventional brake systems, when the brake pedal is actuated, the pressure from the hydraulic circuit exerts a reaction force back into the driver's pedal. This force varies depending on the braking scenario, vehicle load and road condition. In brake-by-wire systems, however, such feedback from the wheel brake cylinder to the brake pedal is prevented in the normal externally actuated operating mode owing to the separation of a direct hydraulic connection. There is therefore a need to provide the driver with a familiar and comfortable pedal feel despite a lack of direct feedback.

For this purpose, it is known to simulate the feedback using a separate simulator unit. Here, the simulator unit generates a counterforce which acts counter to the actuating force and which has a defined travel-dependent or stroke-dependent profile, also referred to as the characteristic of the simulator unit. It is desirable for the characteristic of the simulator unit to as closely as possible resemble real feedback as is encountered for example in a conventional driver-actuated brake system.

Real feedback is distinguished inter alia by the fact that the counterforce rises initially linearly and only insignificantly, but the rise becomes increasingly more progressive beyond a certain stroke. To implement such a profile, a complex construction is necessary, which combines various linear and non-linear elastic elements and which is actuated by a simulator piston which is connected via a hydraulic connection directly to the pressure chamber of the master cylinder unit.

It is known for example from DE 10 2016 221 403 A1 to arrange components of the simulator unit in a separate bore in the brake device housing, which bore is closed by means of a flat cover. Such a bore normally has a complex profile in order to accommodate differently dimensioned components and the seal element for sealing off the simulator piston.

The characteristic of the simulator unit, or its specific force-travel profile, must be adapted for different vehicle applications. For this purpose, it is often necessary to change dimensions of the individual components, which influence the bore profile. This makes it necessary to modify the complex brake device housing and produce several variants of this expensive component in order to implement different simulator characteristics.

As such, it is desirable to produce brake devices with different simulator characteristics at lower cost and more efficiently.

### SUMMARY

According to one embodiment, the disclosure provides for the sealing element for sealing off the simulator piston to be fastened to the simulator piston, such that said sealing element slides on a lateral surface of the piston bore when the simulator piston is actuated. In this way, the radial groove no longer needs to be formed directly in the lateral surface of the piston bore, but can be formed much more easily and inexpensively in the outer lateral surface of the simulator piston.

In one embodiment, the piston bore may be formed in a separate simulator housing which is fastened to a brake device housing and which at least partially receives the simulator piston. Thus, for different versions of the simulator unit, it would be necessary to modify only the relatively simple and relatively small simulator housing, and no longer the complex brake device housing.

For particularly simple production of the simulator housing, one embodiment provides for the simulator housing to be of cup-shaped, thin-walled form with a substantially constant wall thickness. For this purpose, the simulator housing may for example be produced effectively and inexpensively from sheet metal by deep drawing.

For the fastening of the simulator housing to the brake device housing, all that is required on the brake device housing is a receiving seat, which can be produced relatively easily, with an interface for the sealed fastening of the simulator housing, such that the machining effort, and the volume of material removed by cutting from the brake device housing, are significantly reduced. Furthermore, for ease of assembly, all components of the simulator unit may be accommodated in the simulator housing and if required even shipped in a pre-installed state therein, whereby assembly effort can likewise be significantly reduced.

For efficient and secure fastening of the simulator unit, the disclosure proposes that the simulator housing be hydraulically sealingly fixed to the brake device housing by way of a plastic deformation of part of the brake device housing, for example by calking. In this way, additional seals can be omitted, and the assembly cycle time can be shortened.

To prevent a functionally disruptive accumulation of pressure medium in the simulator housing, the disclosure proposes that at least one drainage opening extends through a wall of the simulator housing, through which at least one drainage opening any pressure medium that has ingressed can flow out of the simulator housing.

To ensure the outflow of the pressure medium in all operating states of the simulator unit, the disclosure proposes that the drainage opening is arranged axially in a region between an actuated end position of the sealing element and the elastomer element, such that said drainage opening cannot be covered by any of the internal components.

In order that the outflowing pressure medium does not escape into the surroundings, the disclosure proposes that the drainage opening opens out of the simulator housing into a separate collecting chamber which is hydraulically sealingly isolated from the surroundings of the brake device.

In one exemplary embodiment, the collecting chamber may be isolated by a separate cover that is additionally provided for at least one other component of the brake device, for example a cover of the electronic control unit or of a valve assembly.

In another embodiment, the collecting chamber may be isolated by a separate isolating element that acts directly between the simulator housing and the brake device housing.

In order that the brake device can be arranged in different spatial orientations and angular positions without further modification, and in order to simplify the construction of the collecting chamber, the disclosure proposes that the collecting chamber annularly radially externally surrounds the simulator housing at least in the region in which the drainage opening opens out, or encloses the entire simulator housing.

In an exemplary embodiment, in order to make the construction of the simulator unit more efficient and less expensive, the thrust piece that is provided for introducing forces from the simulator piston into the elastomer element may be of thin-walled form with a substantially constant wall thickness. In this way, said thrust piece can for example particularly efficiently and inexpensively be punched out of sheet metal, ideally in a single working operation.

### BRIEF DESCRIPTION OF THE DRAWINGS

Further Features and Advantages of the Disclosed Subject Matter Will Become Apparent from the Following Description. In the Figures:

FIG. 1 shows an exemplary brake device in an exterior view (a) and in a highly simplified diagram of the internal structure (b).

FIG. 2 shows a detail view of a first embodiment of the brake device, with a first variant of the improved simulator unit in a non-actuated initial state, in an axial section.

FIG. 3 shows a detail view of a second embodiment, with a different simulator unit and with the collecting chamber being isolated in a different way, in an axial section.

### DETAILED DESCRIPTION

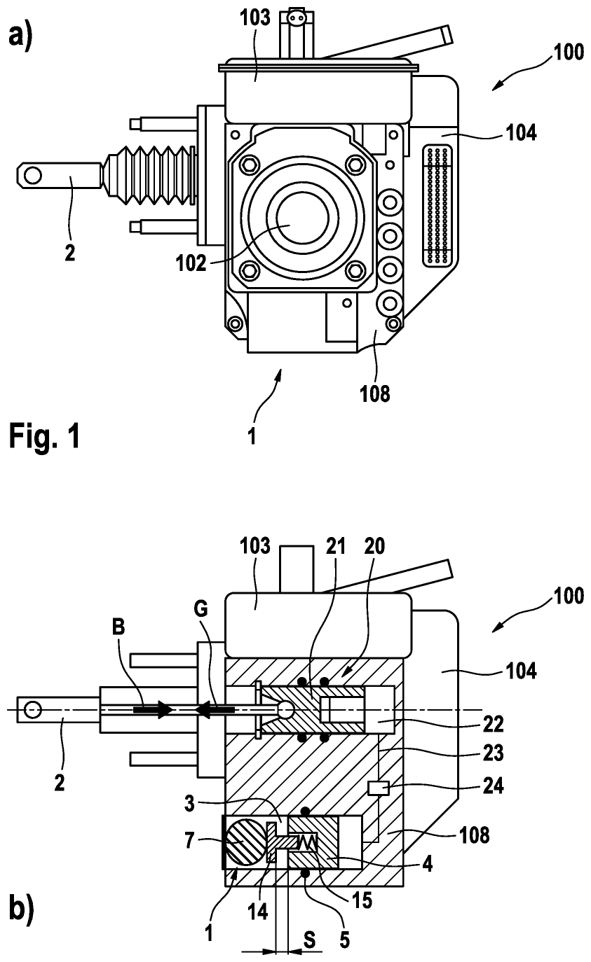

FIG. 1 shows, by way of example, a generic brake-by-wire brake device 100 for a hydraulic brake system of a motor vehicle.

To initiate a braking operation, the driver uses a brake pedal (not illustrated here) to actuate an actuating member 2 that is coupled to said brake pedal. In a normal braking mode, this actuation is detected by a sensor device (not shown here) and processed in the electronic control unit 104. The control unit 104 thereupon activates an electromotive drive unit 102, which uses a separate pressure-generating device (not illustrated here either) to generate the required brake pressure. A pressure medium container 103 feeds the required pressure medium, for example a brake fluid, to the brake device 100.

The actuating force B from the driver is transmitted to a master cylinder piston 21 which, in a master cylinder unit 20 that is arranged in the brake device housing 101, delimits a pressure chamber 22 that is filled with the hydraulic pressure medium. In the normal braking mode described above, the pressure chamber 22 is hydraulically connected, via a connection 23, to a simulator unit 1 that is arranged in the brake device housing 101 of the brake device 100.

Outside normal braking operation, in a so-called fall-back level, the hydraulic connection 23 is shut off by a shut-off valve 24, and the pressure chamber 22 is instead connected, via further lines that are not shown here, directly to the wheel brakes, which are likewise not illustrated here.

The simulator unit 1 has a piston bore 3 formed in the brake device housing 101. Situated in series in said piston bore are a simulator piston 4, a spring element 15 with a preferably linear spring characteristic, a pressure-resistant thrust piece 14, and an elastomer element 7 with a preferably progressive spring characteristic.

When the master cylinder unit 10 is actuated, the hydraulic pressure medium is displaced out of the pressure chamber 11 into the simulator unit 1 and impinges on the simulator piston 4. The simulator piston 4 is thus displaced axially in the direction of the elastomer element 7. A sealing element 5, normally in the form of a sealing sleeve, serves for sealing off the simulator piston 4 in the piston bore 3 in order to prevent a flow of the pressure medium past the simulator piston 4 through the marginal radial gap.

In most embodiments, the simulator piston 4, in its non-actuated initial position, has an axial spacing S to the thrust piece 14. As this axial spacing S, also referred to as idle travel, is passed through, the spring element 15 that is braced between the simulator piston 4 and the thrust piece 14 is compressed.

After the idle travel S has been passed through, the simulator piston 4 lies against the thrust piece 14 and displaces the latter, whereby the elastomer element 7 is compressed.

A resistance that arises in the simulator unit 1, in particular owing to the spring element 15 and the elastomer element 7, during the actuating operation is perceived by the driver as a counterforce G acting counter to the actuating force B, the magnitude of which counterforce characteristically varies along the actuating travel in a manner dependent on the construction and design of individual components of the simulator unit 1.

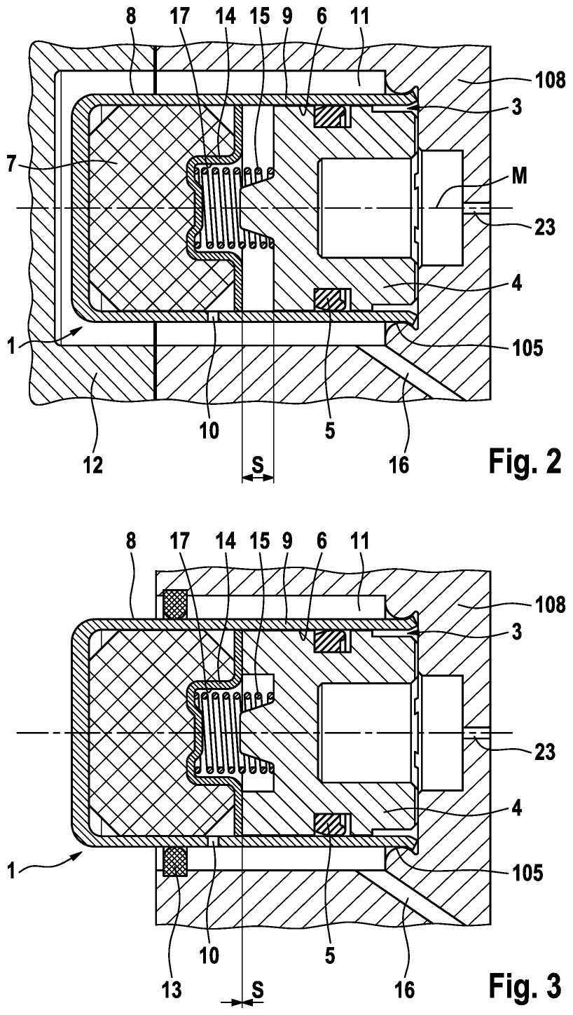

FIG. 2 shows a first embodiment of the simulator unit 1 according to the disclosure in a non-actuated initial state.

By contrast to the known embodiment described above, the piston bore 3 is formed not directly in the brake device housing 101 but in a separate simulator housing 8 that receives the individual components of the simulator unit 1. In the exemplary embodiment shown, the piston bore corresponds to the inner lateral surface 6 of the simulator housing 8.

The simulator housing 8 is cup-shaped and rotationally symmetrical about the central axis M, with a thin wall that has a constant thickness substantially throughout. Such a housing can for example be produced particularly inexpensively as a deep-drawn part from sheet metal.

The simulator housing 8 is directly, non-releasably, and hydraulically sealingly connected to the brake device housing 101. For this purpose, the edge of the simulator housing 8 is flared or flanged radially outward, and a corresponding circular receiving seat 105 is formed on the brake device housing 101. The simulator housing 8 is, at its edge, plugged into the receiving seat 105 and calked therein. During the calking operation, the material of the brake device housing 101 in the edge region of the receiving seat 105 is plastically deformed such that the two parts are non-releasably wedged together, thus generating a force-fitting and form-fitting and hydraulically sealed connection.

The hydraulic sealing action may be generated by way of direct contact between the simulator housing 8 and the brake device housing 108. However, the sealing may likewise be implemented with the aid of further seal elements or seal materials.

In this embodiment, the thrust piece 14 is, like the simulator housing 8, produced in thin-walled form and with a constant wall thickness from sheet metal by deformation, for example by punching. In cross section, the thrust piece 14 has a centrally arranged depression 17. This depression 17 receives the spring element 15 that is braced between the thrust piece 14 and the simulator piston 4, and prevents the spring element from tilting under load.

The sealing element 5 of the simulator unit 1 according to the disclosure is fastened on the simulator piston 4 in a radial groove, such that, during an actuation, the sealing element slides on the piston bore 3 or the inner lateral surface 6 of the simulator housing 8.

In practice, wear or excess pressure, for example, can have the effect that small quantities of the pressure medium flow past the sealing element 5 and collect in the simulator housing 8 in the region between the housing base and the simulator piston 4, displacing the air out of this region. If relatively large quantities of the incompressible pressure medium were to collect in this region, the simulator piston 4 would no longer be able to move during an actuation. This would mean a total failure of the simulator unit 1.

To prevent such a malfunction, one or more drainage openings 10 is or are provided in the simulator housing 8, through which drainage openings the pressure medium that has ingressed into the simulator housing 8 past the sealing element 5 can flow out again. The drainage opening 10 is an aperture through the wall of the simulator housing 8, and may for example take the form of a bore or a slot. In order that the outflow of the pressure medium remains as unhindered as possible, the drainage opening 10 is arranged axially in a region between the elastomer element 7 and the sealing element 5 when the latter is in its maximally actuated position, that is to say at its greatest possible distance from the non-actuated initial position.

Outside the simulator housing 8, the drainage opening 10 opens out into a separate collecting chamber 11 which, in the embodiment shown, externally encloses substantially the entire simulator housing 8. Via an outflow channel 16, the pressure medium passes out of the collecting chamber 11 into a drainage system (not shown here) of the brake device 100, which feeds the collected brake fluid back to the brake circuit again.

To prevent an uncontrolled escape of the pressure medium into the surroundings of the brake device 100, the collecting chamber 11 is hydraulically sealingly isolated from the surroundings. In the embodiment shown, the collecting chamber 11 is isolated by a cover 12 of another component of the brake device 100, for example a cover of the control unit 104, which is correspondingly augmented and shaped for this purpose.

FIG. 3 shows other embodiments of the brake device 100 and of the simulator unit 1.

By contrast to the embodiment according to FIG. 2, the collecting chamber 11 substantially annularly surrounds the simulator housing 8 at its radial outer circumference, in particular in the region in which the drainage opening 10 opens out.

To isolate the collecting chamber 11 with respect to the surroundings, a separate annular isolating element 13 is provided which acts sealingly directly between the simulator housing 8 and the brake device housing 101.

In the embodiment shown, the axial spacing S, or the idle travel, between the simulator piston 4 and the thrust piece 14 is furthermore reduced to 0, such that the simulator piston 4 lies on the thrust piece 14 even in the non-actuated initial state. The characteristic of such a simulator unit 1 would be strongly progressive from the outset, which would result in a hard, direct brake pedal feel, such as may be encountered for example in very sporty vehicles. In this embodiment, the spring element 15 serves substantially as a form of restoring spring. After the end of the braking operation, the simulator piston 4 is more quickly and more reliably set back into its non-actuated initial position by the spring element 15 than would be the case solely as a result of a relatively inert reaction of the elastomer element 7. Furthermore, the spring element 15 ensures that the thrust piece 14 is always pressed against, and always remains in contact with, the elastomer element 7, irrespective of the piston position.

1. A brake device for a hydraulic vehicle brake system, comprising:
at least one simulator unit for generating a counterforce which acts counter to an actuating force and which is fed back to an actuating member of the brake device,
the simulator unit having at least one hydraulically actuated simulator piston, which is axially displaceable in a piston bore, and
the simulator unit also having at least one sealing element for sealing off the simulator piston in the piston bore,
wherein the sealing element is fastened to the simulator piston, and slides on a lateral surface of the piston bore when the simulator piston is actuated.

2. The brake device as claimed in claim 1, wherein the simulator piston, at least along part of its displacement travel, mechanically acts indirectly or directly on an elastomer element and causes an elastic deformation of the elastomer element.

3. The brake device as claimed in claim 2, wherein the piston bore is formed in a separate simulator housing which is fastened to a brake device housing and which at least partially receives the simulator piston.

4. The brake device as claimed in claim 3, wherein the simulator housing is of cup-shaped, thin-walled form with a substantially constant wall thickness, and in particular is formed as a deep-drawn part from sheet-metal material.

5. The brake device as claimed in claim 3, wherein the simulator housing is fastened by way of a plastic deformation of part of the brake device housing.

6. The brake device as claimed in claim 3, wherein at least one drainage opening extends through a wall of the simulator housing.

7. The brake device as claimed in claim 6, wherein the drainage opening is arranged axially in a region between an actuated end position of the sealing element and the elastomer element.

8. The brake device as claimed in claim 6, wherein the drainage opening opens out of the simulator housing outwardly into a separate collecting chamber which is hydraulically sealingly isolated from the surroundings of the brake device.

9. The brake device as claimed in claim 8, wherein the collecting chamber is isolated by a separate cover for another, further component of the brake device.

10. The brake device as claimed in claim 8, wherein the collecting chamber is isolated by an isolating element (13) that acts between the simulator housing and the brake device housing (101).

11. The brake device as claimed in claim 8, wherein the collecting chamber radially externally surrounds the simulator housing at least in a region in which the drainage opening opens out.

12. The brake device as claimed in claim 2 wherein at least one thrust piece (14) is arranged between the simulator piston and the elastomer element and is configured to introduce forces from the simulator piston into the elastomer element, and wherein at least part of the thrust piece bears against the elastomer element at all times.

13. The brake device as claimed in claim 12, wherein at least one spring element is arranged between the simulator piston and the thrust piece.

14. The brake device as claimed in claim 12, wherein the thrust piece is of thin-walled form with a substantially constant wall thickness.

15. The brake device as claimed in claim 14, wherein the thrust piece is formed from sheet-metal material.
